(19) United States
(12) Patent Application Publication
(10) Pub. No.: US 2006/0244862 A1
(43) Pub. Date: Nov. 2, 2006

(54) Clock generation circuit and teletext broadcasting data sampling circuit

(75) Inventor: Kenji Yamashita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 11/411,057

(22) Filed: Apr. 26, 2006

(30) Foreign Application Priority Data
Apr. 28, 2005 (JP) 2005-130831

(51) Int. Cl. H04N 7/00

(52) U.S. Cl. 348/473

(57) ABSTRACT

In an embodiment of the present invention, a maximum value detection circuit and a minimum value detection circuit respectively detects maximum value peaks and minimum value peaks in which CRI included in a text signal of teletext broadcasting indicates “1” or “0”. A reference timing generation circuit calculates a reference timing using the maximum and minimum value peak so as to identify a phase of a sampling clock. The reference timing is a start timing of the sampling clock. Further, a pulse generator generates a sampling clock using a pre-registered cycle with the sampling clock reference timing as a reference.

### BACKGROUND OF THE INVENTION

1. Field of the Invention

The present invention relates to a sampling clock generation circuit and a teletext broadcasting data sampling circuit suitable for using in a teletext broadcasting data receiving circuit of a television video signal.

2. Description of Related Art

A teletext broadcasting superimposes information such as a static image including text and simple graphics in a form of a digital signal on an airwave to transmit. A receiver stores the digital signal to a memory and the like, and then the digital signal is converted into a television video signal so as to display on a television receiver. A system for transmitting texts and graphics in a form of data together with telecast is internationally referred to as a teletext.

A signal of a teletext broadcasting (hereinafter referred to as a text signal) is superimposed in a vertical blanking interval of a television video signal, and exists after a color burst signal, as shown in FIG. 1. A binary NRZ code is adopted for a transmission code of a text signal, and if a pedestal level is 0% and a white level is 100%, a logical value “0” is transmitted as 0% and a logical value “1” is transmitted as 70%. A text signal is comprised of a Clock Run In (CRI) constituted of a 16 bits data “1010101010101010”, 8 bits framing code (FRC), and a data packet, in this sequence.

FIG. 2 is a view showing a process of receiving such text signal and sampling a superimposed text data. As show in FIG. 2, the text signal received is compared to a slice level. Slicing a text signal binarize the text signal, then the text signal is retrieved as a slice data with a digital value “1” or “0”. A sampling clock for sampling a text signal is generated by a phase of CRI etc. in the text signal as a reference. In this case, a sampling point for a data must be configured to be a midpoint between transition points of the text signal. A level of the slice data at a rising point of a sampling clock is read to generate a sampled data.

As shown in FIG. 3, in an actual television receiver, an external noise is often superimposed on a received signal (original signal) due to an external weak electric field and/or an influence of ghost at a receiving time. This could cause an original signal to become a signal with delayed text signal owing to an external noise. In such a case, a sampled data not matching with an expected value is generated. That is, a correct sampling data may be generated. To accurately generate a sampled data, timings of a slice level and a sampling clock need to be configured with a consideration to an influence of external noise.

In a conventional technique, there are suggested methods which are to configure fixed timings and to adjust timings using CRI. In the method to configure fixed timings, a first sampling timing is set to a timing after a certain pre-registered time from a falling edge of a horizontal synchronization signal. The certain pre-registered time here is determined by a specification of a text signal. An example is explained hereinafter in sampling a data of a text data multiplex broadcasting, which is “ARIB (Association of Radio Industries and Businesses) STD-B5 Standard Television Data Multiplex Broadcasting in a Transmission Method Using Vertical Blanking Interval”. In this case, a start timing of a text signal will be 56×Tb from a falling edge of a horizontal synchronization signal (wherein Tb is a period for 1 bit of a transmission code and it is approximately 175 ns in ARIB STD-B5). Thus a sampling start position of the text signal can be calculated as 56.5×Tb (approx. 9.87 us) to be suitable.

A conventional method of adjusting timings is described hereinafter in detail that uses CRI, which is disclosed in Japanese Unexamined Patent Application Publication No. 61-88679 in reference to a teletext broadcasting data sampling circuit shown in FIG. 4. A teletext broadcasting data sampling circuit 400 includes a comparator 401, a sampling clock generation circuit 402, a data sampling circuit 403, and a slice level generation circuit 404.

The comparator 401 compares a text signal with a slice level so as to generate a slice data. The sampling clock generation circuit 402 generates a slice level adjustment value and a sampling clock from the slice data by a method described later. The data sampling circuit 403 synchronizes with the sampling clock, samples the slice data and generates a sampled data. The slice level generation circuit 404 generates a slice level from a slice level adjustment value by a method described later.

The sampling clock generation circuit 402 is described hereinafter in detail. FIG. 5 is a detailed circuit diagram for explaining the sampling clock generation circuit 402. A configuration is explained to begin with. A slice data is inputted to a first AND gate 501 and a second pulse generator 502. An output 603 from the first AND gate 501 is inputted to a first counter 503. A clock from an oscillator 504 is inputted to the first AND gate 501, a first pulse generator 505, and a second AND gate 506. An output 604 from the first pulse generator 505 is inputted to the second pulse generator 502 and a third pulse generator 509.

An output 605 from the second pulse generator 502 is inputted to the second AND gate 506. An output 606 from the second AND gate 506 is inputted to a second counter 507. Outputs from the first counter 503 and the second counter 507 are inputted to an adder 508. An output from the first counter 503 will be a slice level adjustment value. An output from the adder 508 is inputted to a third pulse generator 509. The third pulse generator 509 generates a sampling clock and output it.

An operation of the sampling clock generation circuit is described hereinafter in detail. FIG. 6 is a timing chart showing an operation of the sampling clock generation circuit 402. The oscillator 504 generates a clock needed for a process described later. For example if sampling a data from a teletext data multiplex broadcasting for ARIB STD-B5, an oscillation frequency of the clock is 45.8 MH, which is 8 times higher than a data transfer clock frequency of teletext broadcasting, which is 5.727 MHz.

1) When a slice data shown in FIG. 6 is “1”, a clock from the oscillator 504 is outputted as a signal 603 through the first AND gate 501. The first counter 503 to receive the signal 603 counts the number of clocks in the output signal 603 illustrated in FIG. 6. The first counter 503 counts the clocks when the slice data is “1”, and sums up the clocks 8 times of the slice data “1”.

2) The first pulse generator 505 generates a pulse 604 shown in FIG. 6 with double interval of a period Tb for a one bit of transmission code.

3) The second pulse generator 502 generates a signal 605 that becomes “1” from a rising edge of the pulse 604 to a rising edge of the slice data.

4) A clock is outputted from the oscillator 504 through the second AND gate 506 while the signal 605 is “1” as a signal 606. The second counter 507 to receive the signal 606 counts the number of clocks in the output signal 606 illustrated in FIG. 6. The second counter 507 counts the clocks when the slice data is “1”, and sums up the clocks 8 times of the slice data “1”.

5) A most appropriate calculation method of a sampling clock is described hereinafter in reference to FIG. 7. FIG. 7 is a view showing a relationship between a text signal and a pulse 604. An interval between a rising edge of the pulse 604 (referred to as a timing Tw) and a rising edge of the text signal (referred to as a timing Tx) is hereinafter referred to as T1, while half a period between a timing Tx and a falling edge of the text signal (referred to as a timing Tz) is hereinafter referred to as T2. An optimum sampling time of the text signal (referred to as a timing Ty) is a timing Ty, determined by T1+T2 from the timing Tw to start from.

Accordingly, the adder 508 adds up and outputs 1/16 of a value of an output from the first counter 503 (½ of an average time interval of 2×T2, which is T2) and ⅛ of a value of an output from the second counter 507 (an average time interval T1). Namely an output from the adder 508 indicates an interval (T1+T2) between the pulse 604 (timing Tw) and the optimum sampling timing (timing Ty).

6) The third pulse generator 509 generates a sampling clock that rises at a timing Ty based on an output from the adder 508 and the pulse 604. A data is sampled using this sampling clock to output a slice data.

7) When using 45.8 MHz for a oscillation frequency of the oscillator 504, an output from the first counter 503 is expected to be counted to 8×8=64. However when a slice level moves upward, the count become smaller and when a slice level moves downward, the count becomes larger. That means that referring to an output value from the counter 503 helps optimize the slice level. Accordingly, for example the slice level generation circuit 404 shown in FIG. 4 is comprised of ROM and reads a slice level corresponding to the output value of the counter 503 to output.

Japanese Unexamined Patent Application Publication No. 2002-216424 discloses a multilevel data sampling apparatus for accurately sampling a multilevel data from a reproducing signal of a data recorded with high recording density. Specifically, a reproducing signal of a multilevel data is converted from an analog signal to a digital signal in an A/D conversion portion based on a clock with a shorter cycle than the multilevel data, and then stored to a memory. After that, a synchronous signal detection portion detects a pattern data of a synchronous signal in a memory, and then multilevel data cycle calculation portion detects all maximum values and minimum values from the pattern data.

A time interval between adjacent maximum values and a time interval between adjacent minimum values are computed, and a cycle of a multilevel data is calculated as a half of an average value of all the time intervals. A data extraction portion samples a data from information for each of the cycle with a reference value to be one of the maximum values and the minimum values to output. By computing a cycle of a multilevel data from a time interval between adjacent maximum values and a time interval between adjacent minimum values, a multilevel data can accurately be sampled.

### SUMMARY OF THE INVENTION

According to an aspect of the present invention, there is a sampling clock generation circuit for generating a sampling clock from an input signal that includes a peak detection circuit for detecting a peak of the input signal, a peak timing identification circuit for identifying a timing of a peak detected by the peak detection circuit as a peak timing, a reference timing determination circuit for determining a reference timing to identify a phase of the sampling clock, and a pulse generator for generating the sampling clock.

According to another aspect of the present invention, there is provided a teletext broadcasting data sampling circuit for sampling a text data from a text signal of teletext broadcasting that includes a peak detection circuit for detecting a peak included in a Clock Run In of an inputted text signal, a peak timing identification circuit for identifying a timing of a peak detected by the peak detection circuit, a reference timing determination circuit that determines a reference timing to identify a phase of a sampling clock using the identified peak timing and a sampling clock cycle, and a pulse generator for generating a sampling clock by the reference timing, and a data sampling circuit for sampling a character data included in the text signal.

In this invention, a reference timing to identify a phase of a sampling clock is determined using an identified peak timing and a cycle of a sampling clock. Accordingly a sampling clock can be generated without using a signal that compared a slice level and an input signal, thereby generating a more accurate sampling clock without an influence of slice level accuracy. That is, this invention can generate a more accurate sampling clock.

### BRIEF DESCRIPTION OF THE DRAWINGS

The above and other objects, advantages and features of the present invention will be more apparent from the following description taken in conjunction with the accompanying drawings, in which:

FIG. 1 is a view explaining a teletext broadcasting signal;

FIG. 2 is a view explaining a data sampling from teletext broadcasting;

FIG. 3 is a view explaining a teletext broadcasting data sampling when a delay occurred in a text signal due to an external noise;

FIG. 4 is a circuit block diagram showing a schematic configuration of a teletext broadcasting data sampling circuit according to a conventional technique;

FIG. 5 is a block diagram showing a configuration of a sampling clock generation circuit according to a conventional technique;

FIG. 6 is a timing chart showing an operation of a sampling clock generation circuit according to a conventional technique;

FIG. 7 is a view showing a relationship between a text signal and a pulse 604 according to a conventional technique;

FIG. 8 is a view explaining a teletext broadcasting data sampling when DC component of a text signal is too high due to an external noise.

FIG. 9 is a schematic view showing a configuration of a teletext broadcasting data sampling circuit according to a first embodiment of the present invention;

FIG. 10 is a view showing a configuration of a sampling clock generation circuit according to the first embodiment of the present invention;

FIG. 11 is a view explaining a detection of MAX and MIN according to the first embodiment of the present invention;

FIG. 12 is a view explaining a operation of generating a sampling clock from MAX and MIN according to the first embodiment of the present invention;

FIG. 13 is a view showing a relationship between MAX, MIN, and their counters according to the first embodiment of the present invention;

FIG. 14 is a view showing a configuration of a sampling clock generation circuit according to the first embodiment of the present invention;

FIG. 15 is a schematic view showing a configuration of a teletext broadcasting data sampling circuit according to the first embodiment of the present invention;

FIG. 16 is a view showing a configuration of a circuit according to a second embodiment of the present invention;

FIG. 17 is a view explaining an operation for preventing a incorrect detection of a distorted signal due to an external noise according to the second embodiment of the present invention; and

FIG. 18 is a view explaining an operation for generating a sampling clock when DC component of a text signal is too high due to an external noise according to the second embodiment of the present invention.

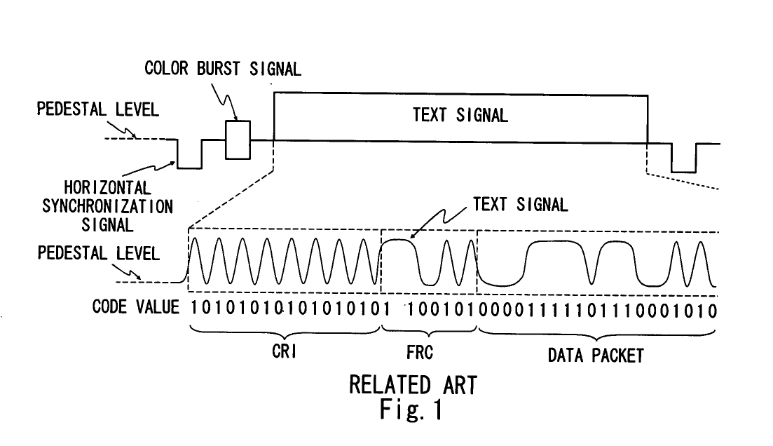

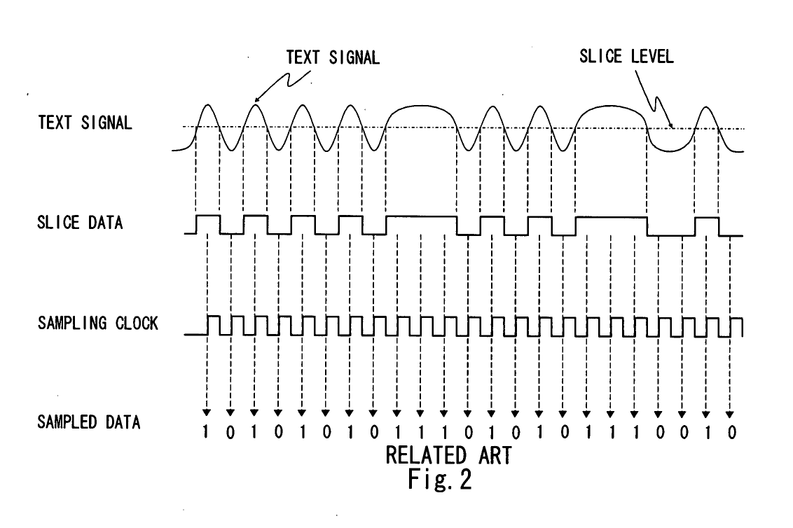

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Embodiments of the present invention are described hereinafter with reference to the drawings. The description hereinbelow is appropriately shortened and simplified to clarify the explanation. In the drawings, identical constituents are denoted by reference numerals identical to those therein with repeated descriptions omitted.

### First Embodiment

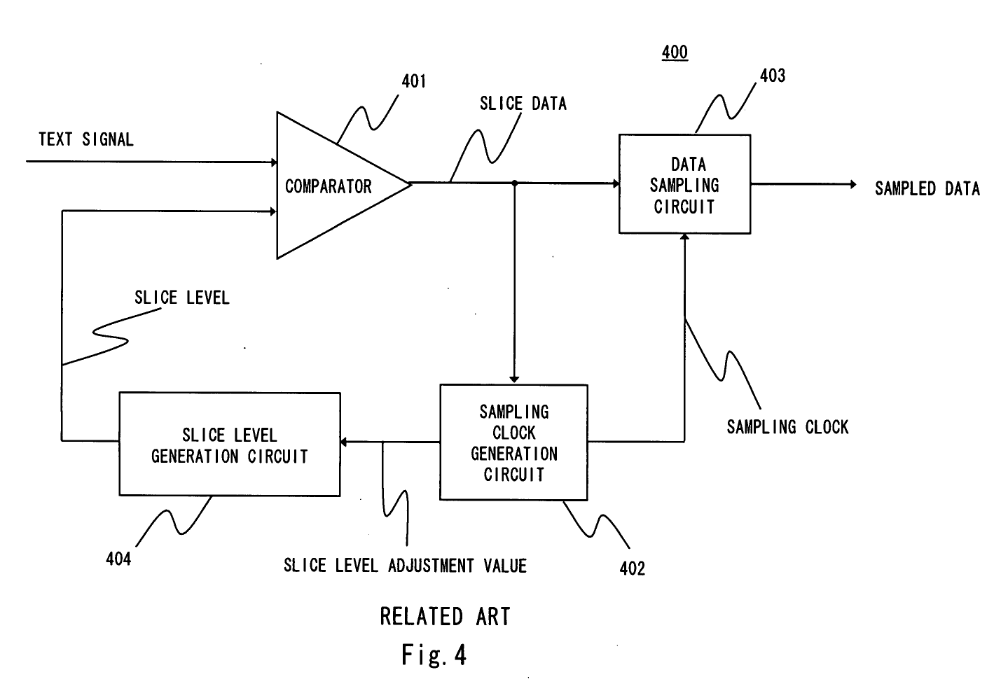

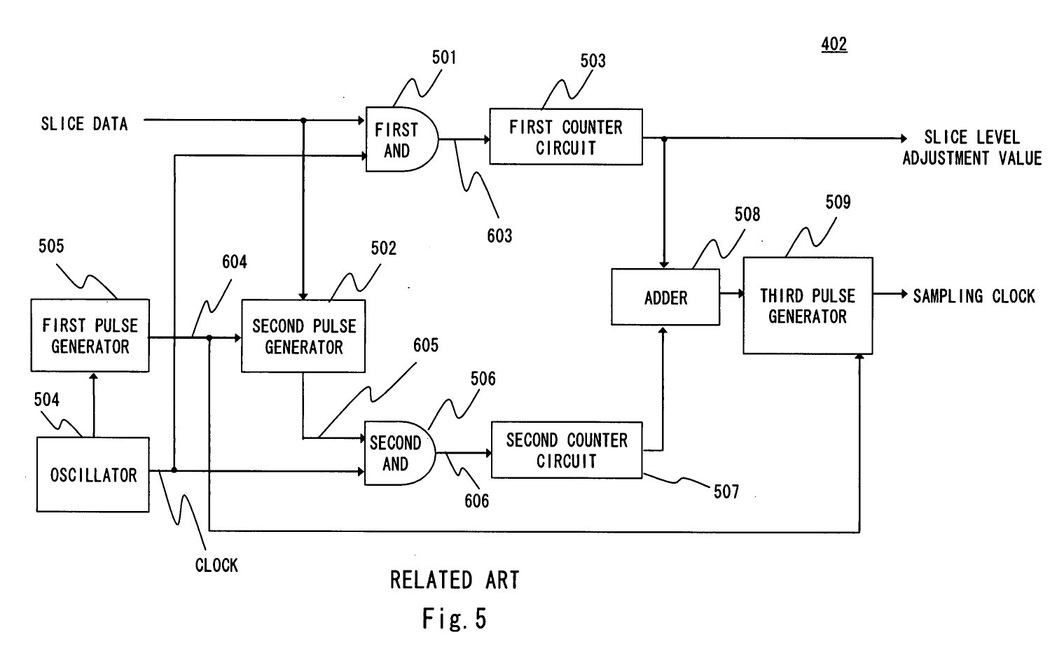

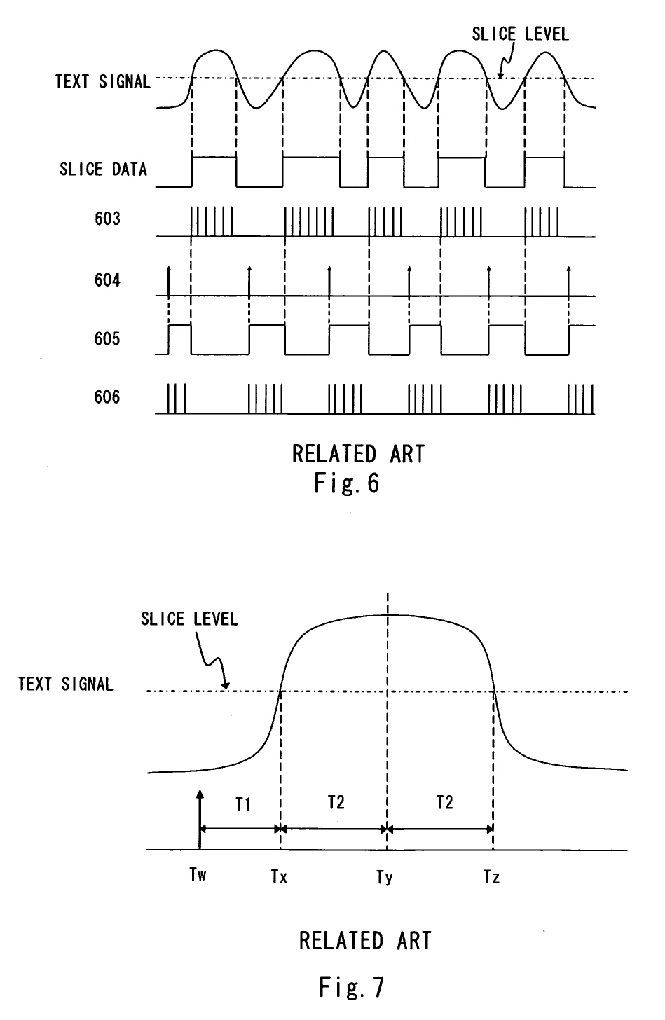

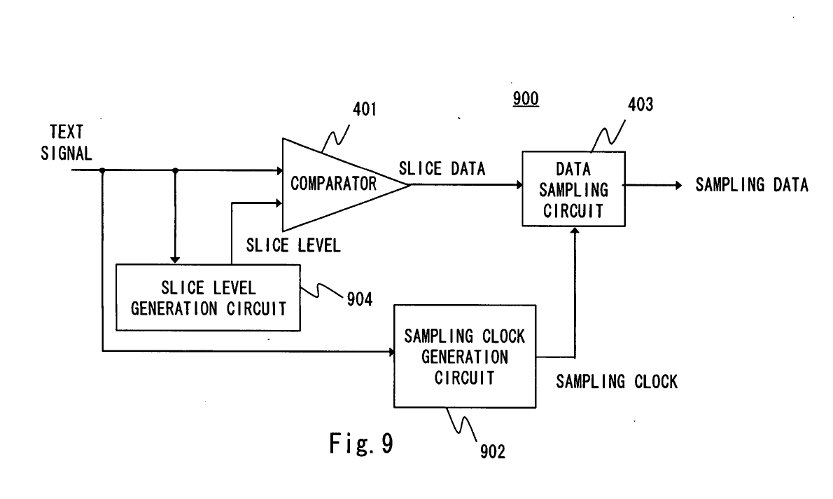

FIG. 9 is a circuit block diagram schematically showing a circuit configuration of a teletext broadcasting data sampling circuit 900 according to a first embodiment of the present invention. In FIG. 9, circuit blocks identical to those in FIG. 4 are denoted by reference numerals identical to those therein. A teletext broadcasting data sampling circuit 900 of teletext broadcasting according to this embodiment includes a slice level generation circuit 904, a comparator 401, a sampling clock generation circuit 902, and a data sampling circuit 403 for generating data.

The slice level generation circuit 904 is supplied with a text signal, and outputs a slice level corresponding to the text signal. The comparator 401 is supplied with the slice level and the text signal. Then the comparator 401 compares a level of the text signal to the slice level as a reference signal and outputs a slice data, which is a binary signal. The sampling clock generation circuit 902 determines a maximum and minimum value of the text signal, and generates a sampling clock corresponding to a text data from the maximum and minimum value. The data sampling circuit 403 samples the slice data synchronized with the sampling clock and generate a sampled data.

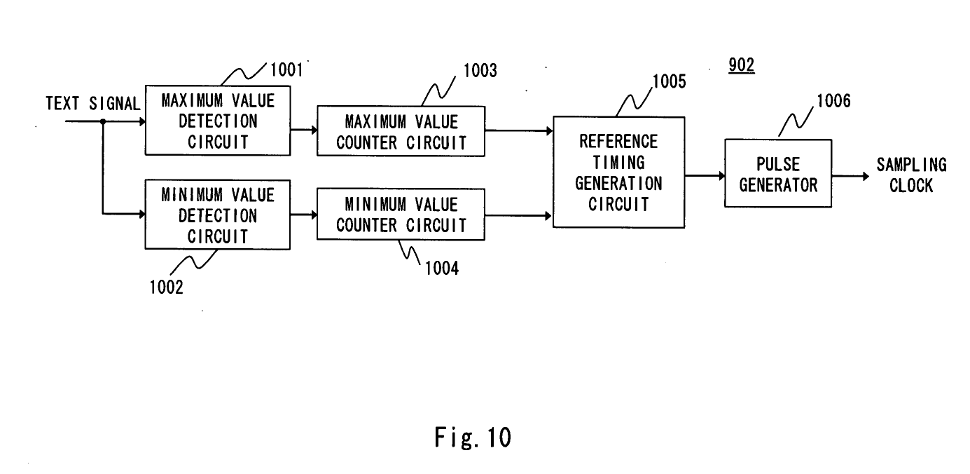

The sampling clock generation circuit 902 is described hereinafter in detail with reference to FIG. 10. The sampling clock generation circuit 902 includes a maximum value detection circuit 1001, a minimum value detection circuit 1002, a maximum value counter circuit 1003, a minimum value counter circuit 1004, a reference timing generation circuit 1005, and a pulse generator 1006.

The maximum value detection circuit 1001 is inputted with a text signal, detects peak of local maximal value (hereinafter referred to as maximum value peak) of the text signal, and outputs a pulse when a maximum value of the text signal is detected. Similarly the minimum value detection circuit 1002 is inputted with a text signal, detects a peak of local minimal value (hereinafter referred to as minimum value peak) of the text signal, and outputs a pulse when a maximum value of the text signal is detected. The maximum value counter circuit 1003 and the minimum value counter circuit 1004 respectively count pulses that detected the maximum value and the minimum value. The reference timing generation circuit 1005 generates a reference timing for identifying a phase of the sampling clock from counter values of the maximum value and the minimum value. The pulse generator 1006 generates a sampling clock based on the reference timing.

A peak detection circuit for detecting a peak of an input signal is configured by the maximum value detection circuit 1001 and the minimum value detection circuit 1002. Further, a peak timing identification circuit is configured by the maximum value counter circuit 1003 and the minimum value counter circuit 1004. A reference timing determination circuit is configured by the reference timing generation circuit 1005.

In this invention, a minimum value peak and a maximum value peak respectively are detected form CRI which consists of “0” and “1” data, and a reference timing to identify a phase of a sampling clock is computed from the minimum value peak and the maximum value peak. In this example, a reference timing is computed by the sampling clock generation circuit 902 of this invention, where the reference timing is capable of identifying a phase of a sampling clock to be generated. A timing supposed to be taken by the reference timing if an ideal transmission is performed is hereinafter referred to as an ideal reference timing. A sampling clock is generated in the pulse generator 1006 using a pre-registered cycle by the reference timing as a reference.

The reference timing may be a timing to identify a sampling clock start, in addition to identify a phase of a sampling clock to be generated. Further, as for a cycle of a sampling clock to be generated, it is possible to have a configuration in which a cycle is determined from an input text signal, which is CRI, a reference timing is determined using the cycle and a sampling clock is generated.

An operation is described hereinafter in detail.

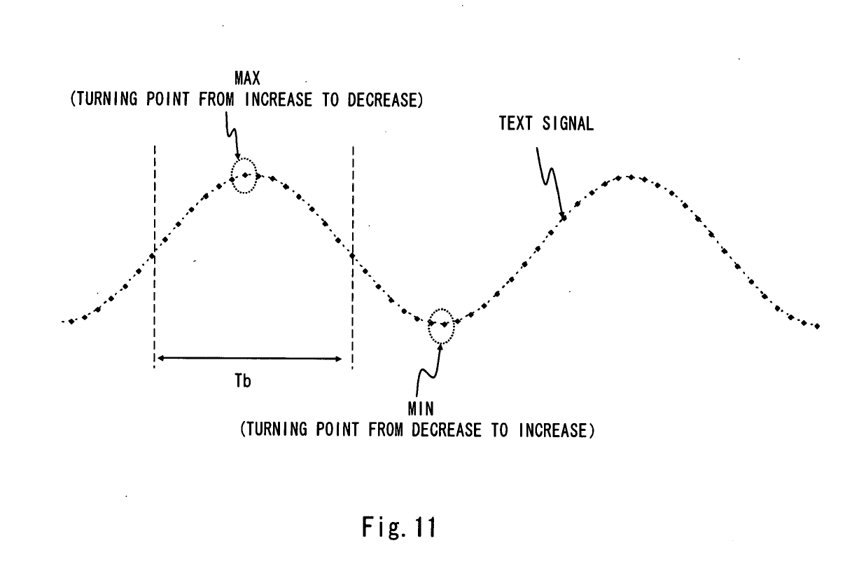

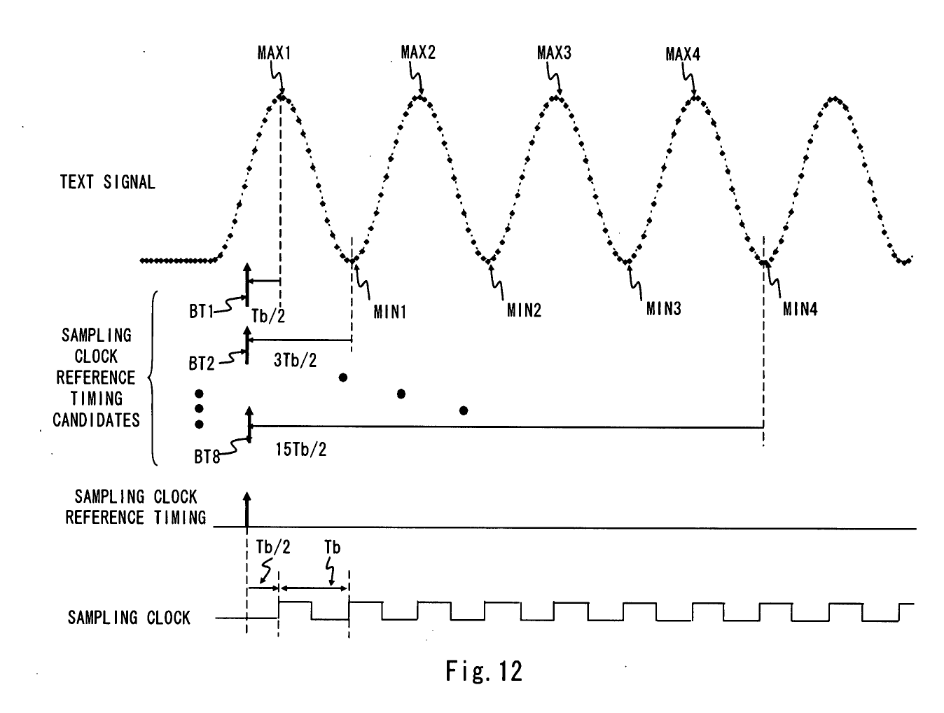

1) FIG. 11 is an input signal shown in FIG. 10. As shown in FIG. 11, there are cases when inputting the input signal as a digital data indicated with a dotted circuit and when inputting the input signal as an analog signal indicated with a dashed line. The sampling clock generation circuit of this invention may be either of the input formats. As for a digital data input, size of inputted digital data is compared in order to determine a maximum and a minimum value. As for an analog data input, an analog signal is converted to a digital data at first, followed by the same process with a digital data to be carried out. That is, as illustrated in FIG. 11, the maximum value detection circuit 1001 detects a maximum value point (i.e. maximum value peak, hereinafter referred to as MAX) where a text signal turns from an increase to a decrease in a plurality data for Tb (a period for 1 bit of transmission code). Similarly, the minimum value detection circuit 1002 detects a minimum value point (i.e. minimum value peak, hereinafter referred to as MIN) where a text signal turns from a decrease to an increase in a plurality data for Tb.

2) The maximum value detection circuit 1001 outputs a pulse every time it detects a MAX, while the maximum value counter 1003 counts the pulse. In other words, the maximum value counter 1003 counts the number of MAX detection. Similarly, the minimum value counter 1004 counts the number of MIN detection every time it detects a MIN.

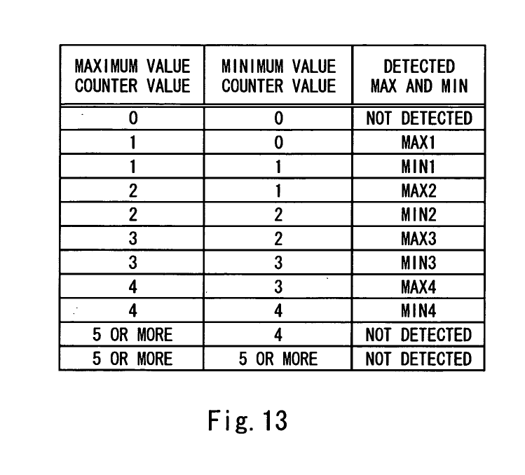

3) An operation of the reference timing generation circuit 1005 is described hereinafter in detail. FIG. 12 is a view explaining an operation for generating a sampling clock from MAX and MIN, while FIG. 13 is a view showing a relationship between MAX, MIN, and their counters.

CRI is a data of “1010101010101010”. An example of an operation for generating a reference timing of a sampling clock using a first 8 bits of “10101010” data is explained hereinbelow. A maximum value data of a plurality data for Tb is indicated by a peak value of “1”, while a minimum value data of plurality data for Tb is indicated by a peak value of “0”. Therefore when values of the maximum value counter 1003 and the minimum value counter 1004 become “maximum value counter value=‘1’ and minimum value counter value=‘0’” for the first time, it means that a first peak value “1” for a CRI (MAX1 in FIG. 12) is detected.

Similarly when values of the maximum value counter 1003 and the minimum value counter 1004 become “maximum value counter value=‘1’ and minimum value counter value=‘1’” for the first time, it means that a first peak value “0” for a CRI (MIN1 in FIG. 12) is detected. Then when values of the maximum value counter 1003 and the minimum value counter 1004 become “maximum value counter value=‘2’ and minimum value counter value=‘1’” for the first time, it means that a second peak value “1” for a CRI (MIN2 in FIG. 12) is detected. Subsequently peak values of “0” and “1” (MIN2, MAX3, MIN3, MAX4, and MIN4) are detected in sequence (see FIGS. 12 and 13).

Then, candidates for a reference timing are determined from detected timings of the maximum and minimum value, using a cycle Tb which is a period for 1 bit of transmission code. As an example, a position of (½)×Tb before a timing position of the MAX1, which is a timing position when an ideal transmission is carried out, to be an ideal reference timing, and reference timings corresponding to the ideal reference timing are computed from detected timings of MAX1 to MAX4 and MIN1 to MIN4.

For example as for a timing that detected MAX1, a position where a period of (½)×Tb before MAX1 is computed as a reference timing candidate (which is BT1 in FIG. 12). For a timing that detected MIN1, a position where a period of ( 3/2)×Tb is subtracted from MIN1 is a sampling clock reference candidate (which is BT2 in FIG. 12), considering a difference of Tb between MAX1 and MIN1.

Candidates for a reference timing are computed from each of MAX and MIN detection points (which are BT1 to BT8 in FIG. 12) in a similar manner. That is, constants corresponding to peak timings of each maximum value is represented by ½+2(M−1), wherein M is a timing sequence of maximum value peaks which is an integer with a value of one or more. On the other hand a constant corresponding to each minimum value peak timing is represented by 3/2+2(N−1), wherein N is a timing sequence of minimum values which is an integer with a value of one or more.

A reference timing is computed as an average value of the reference timing candidates. Computing an average value reduces an influence of noise affected in each detection point. Furthermore by making the number of data to be summed to be a power-of-two, a division needed for calculating an average value can be accomplished by a bit shift.

4) The pulse generator 1006 generates a sampling clock by an obtained reference timing as a reference. As shown in FIG. 12, the sampling clock rises after Tb/2 from the reference timing, with a Tb cycle.

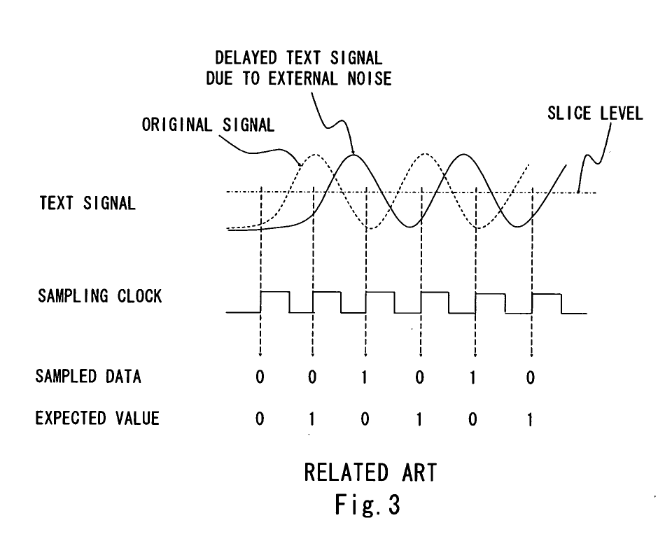

If configuring a fixed sampling start position for a sampling clock, a sampled data differs from an expected value when a received text signal is delayed due to an external noise as shown in FIG. 3, consequently a sampled data not being obtained correctly.

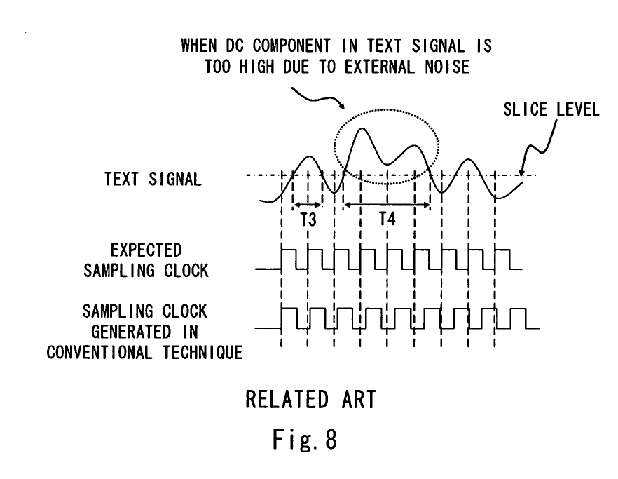

Alternatively, a method of creating a sampling clock using CRI, which is disclosed in Japanese Unexamined Patent Application Publication No. 61-88679 as indicated above, has a problem that a proper sampling clock cannot be generated if DC component is too high or low due to external noise, as shown in FIG. 8. In other words, when a text signal does not intersect with a slice level as shown in FIG. 8, an interval of 2×T2 shown in FIG. 7 stretches as with T4, which is supposed to be T3 in FIG. 8. This leads to a sampling clock being calculated and generated to be different from an expected sampling clock.

The above technique disclosed in Japanese Unexamined Patent Application Publication No. 2002-216424 only computes a cycle of a multilevel data from a time interval between adjacent maximum values and a time interval between adjacent minimum values of an inputted signal. It indicates that the technique does not identify an exact phase of a sampling clock.

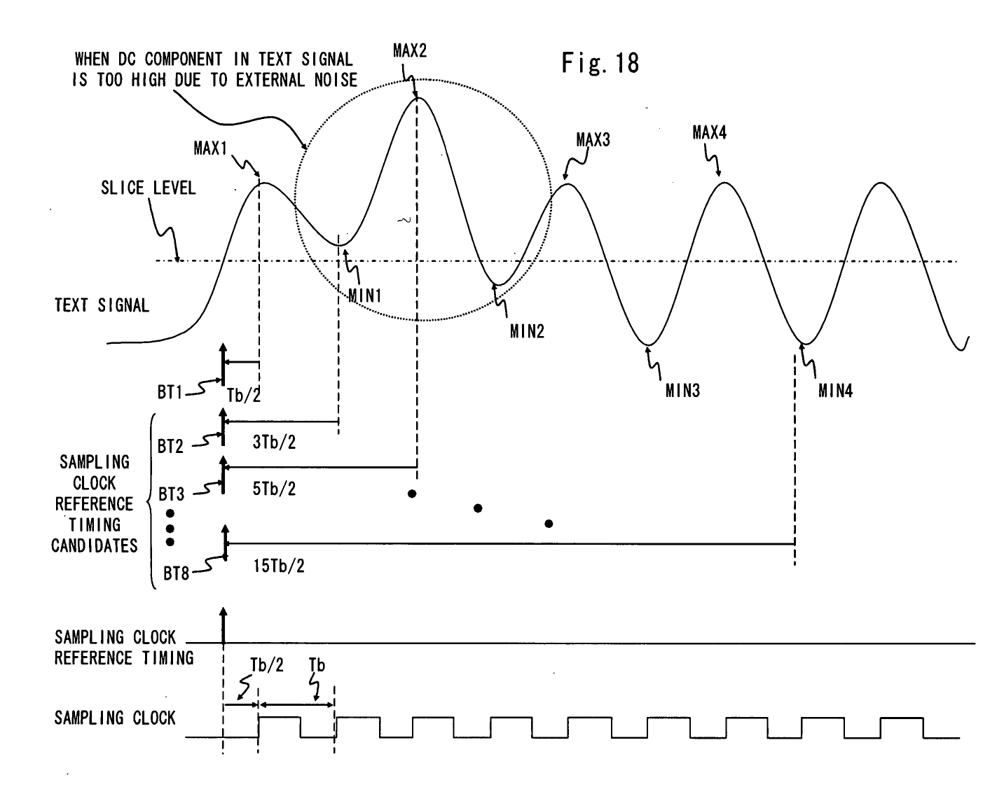

On the contrary, in this embodiment as described so far, since a sampling clock is generated from peak timings of maximum and minimum values (i.e. timing of maximum value peak and timing of minimum value peak) for CRI, a sampling clock can correctly be generated even in a case when DC component become too high or too low, so that a text signal does not cross a slice level as shown in FIG. 18. That is, even when a text signal fluctuates towards a voltage direction, a text signal can be sampled at a correct sampling time.

As described in the foregoing, a plurality of peaks (maximum values or minimum values) is preferably used for a determination of an accurate reference timing, it is possible to determine a reference timing by using one maximum value peak or minimum value peak. A part of the plurality of peaks may be used to determine a reference timing. Alternatively, a plurality of peaks in maximum or minimum values may be detected to determine a reference timing from. Further, when generating a sampling clock from either of maximum values or minimum values, a configuration may be set up in a way to allow a selection of whether to generate a sampling clock from maximum values or minimum values, depending on an external control signal. In such a case, a reference timing is generated only for an output from a selected circuit of either the maximum value detection circuit or the minimum value detection circuit, and then a sampling clock is generated corresponding to the reference timing.

That is, if a peak pattern and a peak interval (interval between peak timings) of an input signal are known in advance, a reference timing can be identified using a peak interval that is obtained from detected peak timings. Furthermore in the first embodiment, an ideal reference timing and a reference timing to be computed are specified as a timing of (½)×Tb before a peak timing of MAX1, however it is possible to configure a circuit by defining an ideal reference timing and a reference timing to be a start position of a desired sampling clock. For example when defining an ideal reference timing and a reference timing to be a peak timing of MAX1, a calculation of adding (½)×Tb can be left out when attempting to retrieve an output start position of a sampling clock (or a rising edge of a sampling clock) after determining a reference timing.

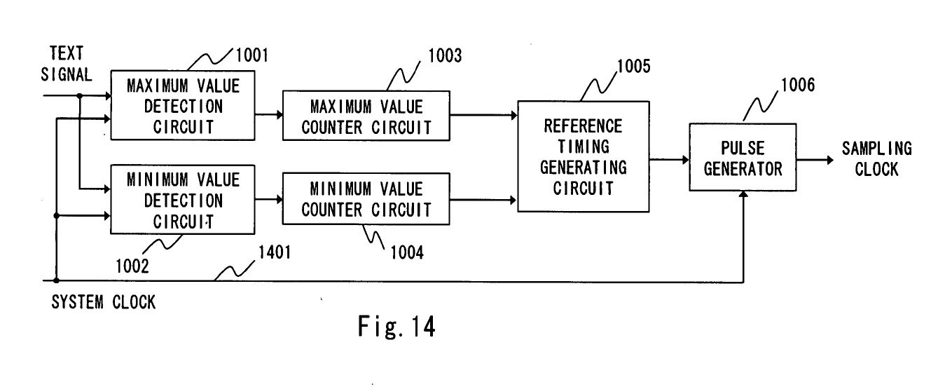

Timings in the first embodiment can be treated as count values of pulses for a system clock inside the sampling clock generation circuit 902 of this invention, for example. FIG. 14 is a configuration in which a system clock 1401 from an oscillator (not shown) is supplied to the configuration of FIG. 10 which comprises the maximum value detection circuit 1001, the minimum value detection circuit 1002, the reference timing generation circuit 1005, and a pulse generator 1006. The system clock 1401 has a higher frequency than a frequency of a sampling clock generated by the sampling clock generation circuit 902 of this invention, with a known operation frequency. The system clock 1401 desirably has a frequency of integral multiples of a frequency of the sampling clock generation circuit 902. Peak timings, MAX1, MIN1, MAX2, MIN2, . . . MIN4 are respectively represented as count values of pulses for a system clock, C1, C2, C3, C4, . . . C8, when the peaks are detected. A count value BCavg corresponding to a reference timing is computed from each of the count values, C1 to C8. Tb (period for 1 bit of transmission code) also can be treated as count value of pulses for a system clock 1401.

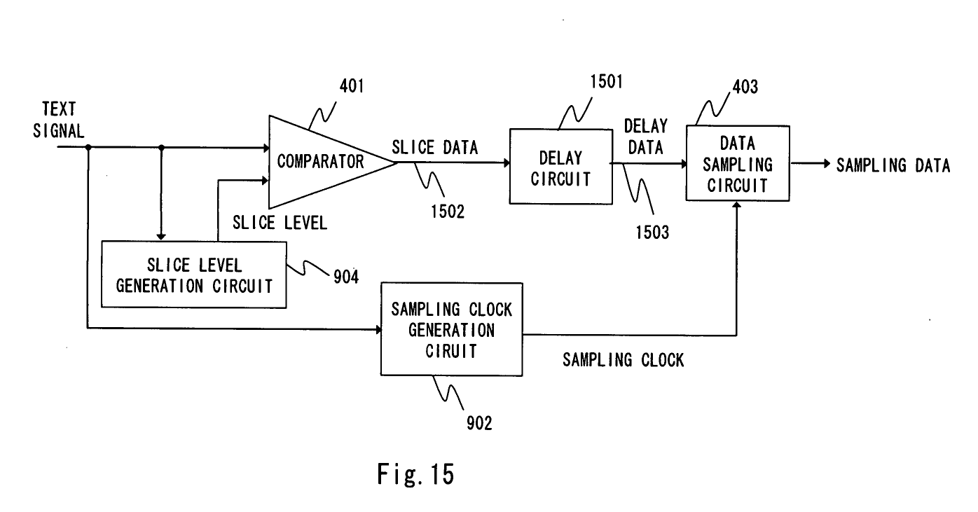

A count value BCstart corresponding to a sampling clock start position is determined from a computed BCavg. The pulse generator 1006 outputs a sampling clock when a count value of pulses for the system clock 1401 reaches BCstart. When retrieving data from a beginning of CRI, BCstart uses a value calculated by adding a value of count value or more (hereinafter referred to as AC), which corresponds to a time difference between a first peak and a last peak of an input signal needed to calculate BCavg, to a value of BCavg. In such a case, a delay circuit 1501 is provided prior to a data sampling circuit 403, as shown in FIG. 15. The delay circuit 1501 outputs a slice data 1502 as a delay data 1503 which is delayed for an amount of delay corresponding to AC. By doing this operation, the data sampling circuit 403 can obtain a desired sampling clock.

It indicates that a sampling clock capable of stable reception (data retrieval) can be generated by determining a reference timing from peaks of an input signal. This is because that a desired start timing for a sampling clock can be computed based on the reference timing.

In a case when a CRI pattern is not required to be sampled (that is, when sampling from text data), a value of BCstart can be determined without adding the delay circuit 1501, so as to meet a timing when a text data is transmitted from a reference timing.

Although an example shown in FIG. 14 uses a count value of pulses for the system clock 1401, it is certainly possible to measure actual time using a timer and such, and then store the time to a register, for example.

### Second Embodiment

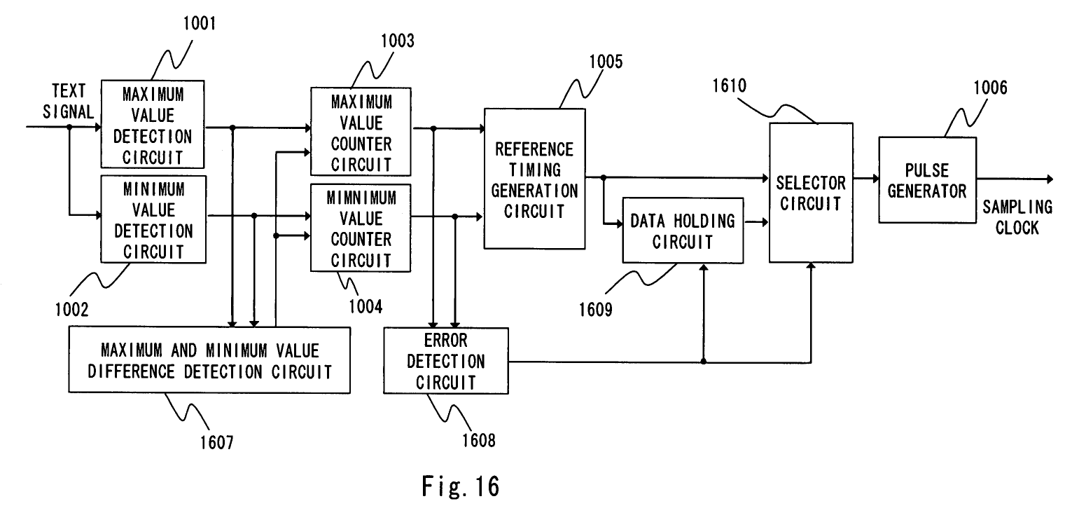

A second embodiment of a teletext broadcasting data sampling circuit of the present invention is described hereinafter with reference to FIGS. 16 to 18. FIG. 16 is a circuit block diagram showing a teletext broadcasting data sampling circuit of the second embodiment. Basic configuration is the same as the first embodiment described with reference to FIG. 10.

Besides the configuration of FIG. 10, a maximum and minimum value difference detection circuit 1607, an error detection circuit 1608, a data holding circuit 1609, and a selector are added. Circuit blocks other than the above are not described here as they are covered by the first embodiment. The maximum and minimum value difference detection circuit 1607 detects a difference between a maximum and a minimum values in timings of output pulses from the maximum value detection circuit 1001 and the minimum value detection circuit 1002. The error detection circuit 1608 detects an error in an output counter value from an maximum value counter circuit 1003 and a minimum value counter circuit 1004. The data holding circuit 1609 holds timing information of a sampling clock reference timing. The selector circuit 1610 selects a reference timing from a reference timing generation circuit 1005 or a reference timing from the data holding circuit 1309.

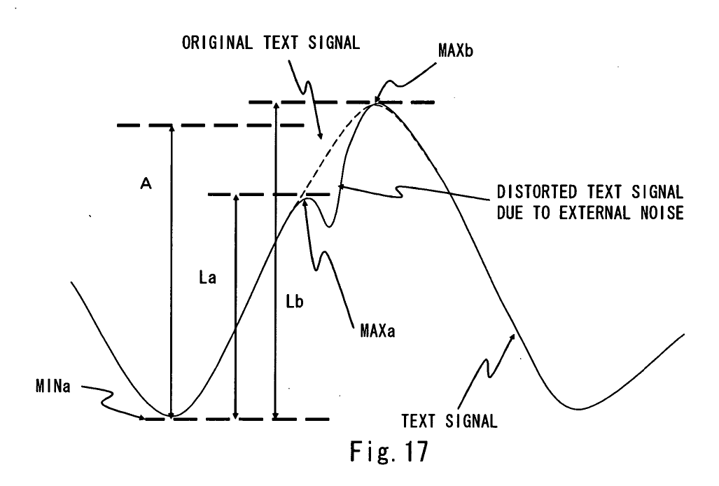

An operation is described hereinafter in detail. The maximum and minimum value difference detection circuit 1607 holds a maximum and minimum values detected just before, and evaluates whether a maximum or a minimum value to be detected next is valid or not. For example, FIG. 17 shows a case when a level falls before an original maximum value point MAXb due to an external noise and a pseudo maximum value point MAXa is generated. In this case, the maximum value detection circuit 1001 detects the pseudo maximum value point MAXa as a maximum value point as well. In such a case, the maximum and minimum value difference detection circuit 1607 computes a level difference La between a level of a minimum value point MINa, which is a last minimum value point to be held, and a detected level of a maximum value point MAXa, recognizes the difference La is small in relation to a reference value A, and output a determination signal to the maximum value counter circuit 1003 to prevent from recognizing the pseudo maximum value point MAXa as a maximum value point.

On the other hand, if the maximum value detection circuit 1001 detects an original maximum value point MAXb, a difference Lb between a level of the minimum value point MINa and a level of the maximum value point MAXb that are computed by the maximum and minimum value difference detection circuit 1607 is recognized as more or less the same in relation to the reference value A, and then a determination signal is outputted to the maximum value counter circuit 1003 so as to recognize and count the maximum value point MAXb as a correct maximum value.

The maximum value counter circuit 1003 recognizes an output pulse from the maximum value detection circuit 1001 originated from the maximum value point MAXa to be invalid with the determination signal from the maximum and minimum value difference detection circuit 1607, while recognizing an output pulse from the maximum value detection circuit 1001 originated from the maximum value point MAXb to be valid and counting this output pulse. A minimum value is counted in the similar manner.

An operation of the error detection circuit 1608 is described hereinafter in detail. Combinations of maximum value counter values and a minimum value counter values are the combinations shown in an abovementioned FIG. 13, and other combinations indicates that MAX and MIN are not properly detected. In the error detection circuit 1608, if a detected maximum or minimum value does not match prescribed numbers, it is regard as an error.

If the error detection circuit 1608 does not detect an error, a selector circuit 1610 selects a reference timing from a timing generation circuit 1005 and outputs the reference timing to a pulse generator 1006, performing in the same manner as with the first embodiment explained with reference to FIG. 10. At the same time, the data holding circuit 1609 receives a reference timing from a reference timing generation circuit 1005 and then holds the reference timing.

If the error detection circuit 1608 detects an error, in a meantime the selector circuit 1610 selects an optimum reference timing of a 1H (horizontal cycle) before a current cycle held in the data holding circuit 1609 and outputs the optimum reference timing to the pulse generator 1006, the data holding circuit 1609 prevents from an incorrect operation by not retrieving a sampling clock reference timing from the timing generation circuit 1005.

When a level fluctuation occurs in a timing other than an original maximum or minimum value due to an external noise, an incorrect recognition of the timing can be prevented. Moreover even when a combination of a maximum value counter and a minimum value counter does not match any of the combinations in FIG. 13 due to other external noises, an incorrect operation of sampling clock generation can be prevented.

To accurately evaluate without an influence from a signal level fluctuation, it is preferable to prevent from an incorrect detection by measuring a difference of levels between continuous peaks as described above, however levels between non-continuing peaks with some separation between them may also be used. It is preferable to use a reference timing in 1H before a current cycle, values further before can be retained. A person skilled in the art will be able to easily change, add, or modify various elements of the above-described embodiments, without departing from the scope of the present invention.

What is claimed is:

1. A sampling clock generation circuit for generating a sampling clock from an input signal comprising:
a peak detection circuit for detecting a peak of the input signal;
a peak timing identification circuit for identifying a timing of a peak detected by the peak detection circuit as a peak timing;
a reference timing determination circuit for determining a reference timing to identify a phase of the sampling clock by using the peak timing identified and a value in a period for 1 bit of transmission code of the input signal; and
a pulse generator for generating the sampling clock by the reference timing as a reference.

2. The sampling clock generation circuit according to claim 1, wherein the reference timing determination circuit determines the reference timing using a value in a period for 1 bit of transmission code of the input signal from the identified peak timing.

3. The sampling clock generation circuit according to claim 1, wherein the reference timing determination circuit determines the reference timing by using peak timings of a plurality of peaks that are detected by the peak detection circuit.

4. The sampling clock generation circuit according to claim 1, wherein the reference timing determination circuit determines reference timing candidates from peak timings of a plurality of peaks that are detected by the peak detection circuit, and then determines the reference timing using an average value of the reference timing candidates.

5. The sampling clock generation circuit according to claim 4, wherein the reference timing determination circuit determines the reference timing candidates by subtracting a value, which is computed by multiplying a constant corresponding to each of the peak timings by a period for 1 bit of transmission code of the input signal, from each of the peak timings.

6. The sampling clock generation circuit according to claim 5,
wherein the plurality of peaks includes a plurality of maximum value peaks and a plurality of minimum value peaks,
constants corresponding to peak timings of each of the plurality of maximum value peaks are represented by ½+2 (M−1) where M is a timing sequence of the plurality of maximum value peaks which is an integer with a value of one or more, and
constants corresponding to peak timings of each of the plurality of minimum value peaks are represented by 3/2+2 (N−1) where N is a timing sequence of the plurality of minimum value peaks which is an integer with a value of one or more.

7. The sampling clock generation circuit according to claim 3, further comprising:
a counting circuit for counting the number of detected maximum value peaks and the number of detected minimum value peaks, and
an error detection circuit determining whether the detected maximum value peaks or the detected minimum value peaks are normal or not, from whether the maximum value peaks and the minimum value peaks are outputted in a prescribed sequence.

8. The sampling clock generation circuit according to claim 1, wherein the input signal is a text signal including a clock run in, a framing code, and a data packet.

9. The sampling clock generation circuit according to claim 1, further comprising a difference calculation circuit for calculating a difference between a maximum value peak and a minimum value peak of the input signal,
wherein if the difference is less or equal to a criteria value, the reference timing determination circuit determines the reference value without one of the maximum value peak and the minimum value peak that is used in a calculation of the difference.

10. The sampling clock generation circuit according to claim 1, further comprising a data holding circuit for holding a past reference timing,
wherein if the number of the detected peaks does not reach a reference number, the sampling clock generation clock generates the sampling clock using the past reference timing.

11. The sampling clock generation circuit according to claim 1, wherein the reference timing determination circuit determines the identified peak timing as the reference timing.

12. The sampling clock generation circuit according to claim 1, wherein the pulse generator generates a sampling clock with a cycle which is a period for 1 bit of transmission code of the input signal, and outputs the sampling clock by adjusting a phase of the sampling clock so that a starting edge of the sampling clock occurs on the reference timing.

13. The sampling clock generation circuit according to claim 1, wherein the pulse generator is inputted the reference timing and outputs the sampling clock by adjusting a phase of the sampling clock so that an edge of the sampling clock occurs on a timing which is determined by adding Z (where Z is an integer) times of a period for 1 bit of transmission code of the input signal to the reference timing.

14. A teletext broadcasting data sampling circuit for sampling a text data from a text signal of teletext broadcasting comprising:
a peak detection circuit for detecting a peak included in a clock run in of an input text signal;
a peak timing identification circuit for identifying a peak timing detected by the peak detection circuit;
a reference timing determination circuit for determining a reference timing to identify a phase of a sampling clock using the identified peak timing and a sampling clock cycle,
a pulse generator for generating a sampling clock by the reference timing as a reference, and
a data sampling circuit for sampling a text data included in the text signal according to the generated sampling clock.

15. The teletext broadcasting data sampling circuit according to claim 14, further comprising a difference calculation circuit for calculating a difference between a maximum value peak and a minimum value peak of the input signal,
wherein if the difference is less or equal to a reference value, the reference timing determination circuit determines the reference value without one of the maximum value peak and the minimum value peak that is used in a calculation of the difference.
